(19) United States
(12) Patent Application Publication
(10) Pub. No.: US 2006/0031291 A1
(43) Pub. Date: Feb. 9, 2006

(54) System and method of video presence detection

(76) Inventor: David S. Beckemeyer, Danville, CA (US)

Correspondence Address: SMITH FROHWEIN TEMPEL GREENLEE BLAHA, LLC, P.O. BOX 88148, ATLANTA, GA, 30356, US

(21) Appl. No.: 10/861,156

(22) Filed: Jun. 4, 2004

(51) Int. Cl. G06F 15/16

(52) U.S. Cl. 709/204

(57) ABSTRACT

The disclosure includes systems and methods of video presence detection. A video presence detection system allows users at one location to monitor the presence of other users at other locations over a network based upon real-time video. Cameras and computer systems are present in each location. A video presence module collects video data from the cameras in each location and provides real-time video to each computer system. The video provided to each system is limited to a user selected set of other users and corresponding locations and uses limited bandwidth such that it can be maintained as a background operation for each computer system.

### BACKGROUND OF THE INVENTION

1. Field of the Invention

The present invention relates to the field of computer-based collaboration tools and, more specifically, systems and methods for locating and communicating with co-workers and associates.

2. Description of the Related Art

Video Conferencing

For many years, video research has concentrated on video conferencing as a substitute for face-to-face meetings. Video conferencing systems are usually justified on the basis of increase productivity or cost-cutting as a direct result of a presumed reduction in travel. While there have been a number of successful installations and applications of video conferencing, the technology has not proven effective in all environments.

The literature offers a great number of reasons for the failures of video conferencing, but the fact is that video conferencing as a substitute for face-to-face communications has never met expectations. Despite all the research in support of this conclusion, as well as low market acceptance of the technology, vendors continue to focus their efforts on the substitution model.

The most common corporate video conferencing platforms require very expensive hardware and dedicated bandwidth for managing the demands of real-time streaming audio and video. They may also require negotiated scheduling through a service provider that manages the backend systems to distribute the video data among various locations. Such systems are marketed as virtual meetings that add a video element to the traditional conference call and are probably the most obvious example of the substitution model, replacing face-to-face meetings.

Other video conferencing platforms utilize existing PC systems, Internet connections, and low-cost web cameras. Person-to-person video calls have become a fairly simple matter using such systems and have started to gain some amount of consumer acceptance (though not widespread consumer adoption). Unfortunately, the bandwidth constraints of most users have led to video applications that provide low-grade video and audio, frequently with a noticeable delay, that many users find objectionable for a communication platform. This problem is compounded by the number of simultaneous streams involved in a conference, which renders such systems a poor substitute for face-to-face communications, especially for a large team.

Presence Detection

The desirability of presence detection is known, if not entirely well understood. The importance of locating co-workers and team members is manifest in a distributed work environment; as anyone who has played phone tag or struggled with catching a co-worker in her office can attest. Prior solutions have included monitoring PC activity (keyboard strokes, mouse movement, etc.), telephone activity, login status to various applications, networks, and systems, motion sensor data, and various location tracking systems (checkpoint systems, wireless triangulation of worker ID tokens, etc.).

Some systems have made activity tracking data available through a networked application that includes access to calendars, attendance tracking systems, contact information, and communication requests in an attempt to facilitate team communication. These systems vary in their complexity, invasiveness, level of workflow integration, and compatibility with workplace norms and conventions. However, they have not met the need for enhanced communication and collaboration among teams for a variety of reasons. In particular, they have not been very effective at enabling opportunistic or spontaneous interactions. They have largely relied upon system-driven availability searching, rather than the natural tendency to strike up a conversation with someone you notice to not be otherwise engaged.

One recent example of a somewhat successful presence detection system is the IM “buddy lists” and associated online indicator. Unfortunately, this form of presence indicator only tells others that the person has their application running and not whether or not they are actually at their terminal, engaged in an exchange with someone else, or otherwise engaged.

Online Collaboration Tools

In addition to video conferencing and presence detection, a wide variety of network-based collaboration tools have been developed for facilitating the work of dispersed teams. These tools include all manner of communication (e.g. e-mail, chat, bulletin board, instant messenger, telephone/VoIP, video conference, etc.) and virtual workspace applications (e.g. document repositories, group editing/drafting tools, whiteboards, presentations, surveys, directories, etc.). Many combinations of these applications, as well as variations on hosting, membership, authentication, privileges/control, and workflow integration, have been tried. However, none of these collaboration tools have adequately addressed the need for impromptu communication.

Studies of workplace communication show that most interaction occurs spontaneously for short periods of time. These unplanned interactions happen naturally when group members are co-located. Despite research from various disciplines showing the value of these informal interactions, evidence indicates that people in the workplace do not recognize their value. Workers tend to overuse formal meetings and underutilize impromptu communications relative to their value. Data indicates that without visual information about the availability of others, connection failure is high. More than 60% of business phone calls fail to reach their intended recipient. There is a need for visual presence detection for distributed collaboration networks.

### SUMMARY OF THE INVENTION

The invention includes systems and methods of video presence detection. A video presence detection system allows users at one location to monitor the presence of other users at other locations over a network based upon real-time video. Cameras and computer systems are present in each location. A video presence module collects video data from the cameras in each location and provides real-time video to each computer system. The video provided to each system is limited to a user selected set of other users and corresponding locations and uses limited bandwidth such that it can be maintained as a background operation for each computer system.

In some embodiments of the invention, the computer systems at the locations interact with a control server that receives the video data from each and sends the appropriate subset of the video data to each. Each client system requires only a single data stream for sending video data, regardless of the number of other client systems. User selection of other user locations to monitor is based upon a combination of subscription list, session-based groups, and glances (ad hoc, short duration looks). The real-time video displayed on each computer system includes thumbnail icons of real-time video for each of the other user locations being monitored and is present whenever the client system is on. The camera in each user location is situated to provide a view of the work areas in the location, as opposed to a close-up of the user. The video presence module may be integrated with a variety of online collaboration tools, such as chat, instant messaging, VoIP, whiteboards, presentation, document repositories, collaborative drafting/editing, directories, and other tools.

### BRIEF DESCRIPTION OF THE DRAWINGS

These and other features of various embodiments of the invention are more fully described below. Reference is made throughout the description to the accompanying drawings, in which:

FIG. 1 is an overview of a video presence detection system.

FIG. 2 is a diagram of two office locations that show camera positioning to capture multiple workspaces.

FIG. 3 is a block diagram of an example client/server video presence detection system.

FIG. 4 is a block diagram of an example video presence control server.

FIG. 5 is a block diagram of an example video presence application.

FIG. 6 is a sequence diagram for an example protocol for communications between a video presence control server and a video presence application on a client system.

FIG. 7 is an example user interface with video presence indicators.

FIG. 8 is an example interface for a video presence application with integrated collaboration tools.

FIG. 9 is an example method of subscription-based video presence detection.

FIG. 10 is an example method of session-based video presence detection.

FIG. 11 is an example method of glance-based video presence detection.

### DETAILED DESCRIPTION OF THE INVENTION

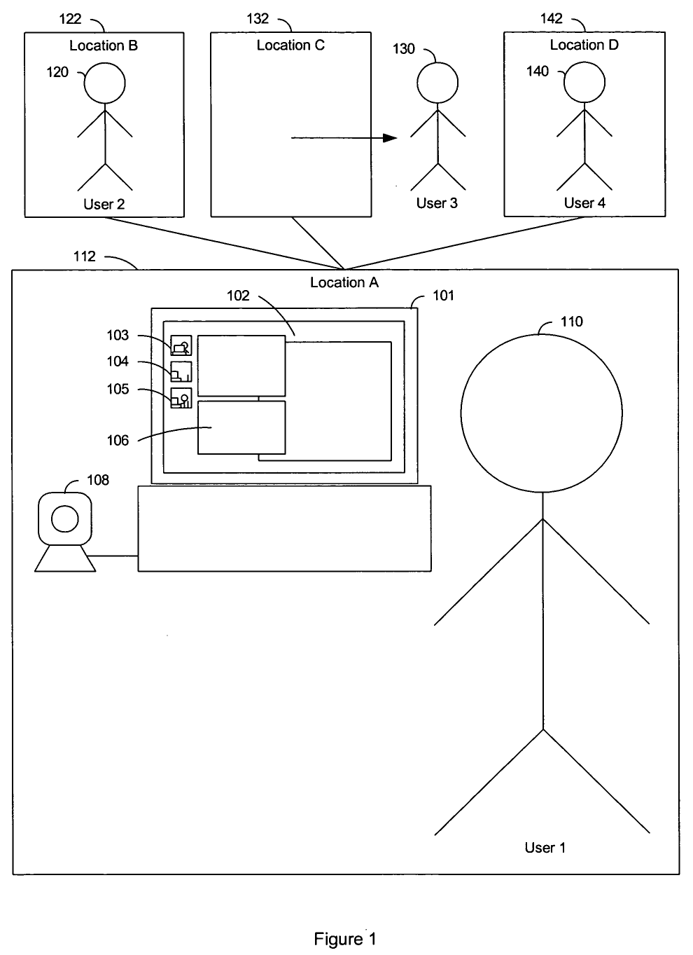

FIG. 1 shows an overview of a video presence detection system. The video presence detection system includes a computer system 101 that is used by a user 110 in location A 112. The video presence detection system allows the user 110 to monitor several remote locations, location B 122, location C 132, and location D 142 for the presence and activities of corresponding other users 120, 130, 140. The video presence detection system also allows the other users 120, 130, 140 to monitor the first user 110 and each other using similar computer systems (not shown).

For example, the users 110, 120, 130, 140 could be members of a team or workgroup on a particular project that have offices distributed within a large office suite, across a campus, or around the world. The team may be composed of users from multiple organizations, including individuals that work for service providers, suppliers, customers, contractors, monitoring organizations, or other entities. All users may not monitor all other users but only a subset of the other users. For example, all users may include an entire organization or department but actual monitoring relationships only exist among those with direct working or personal relationships. For example, a particular project may include a coordinating group that all monitor and communicate with one another on a regular basis and are each then responsible for one or more other individuals in their own department. The coordinating users monitor one another and monitor their subordinates, but do not monitor the subordinates of the others. In the example shown, the first user 110 is monitoring all other users 120, 130, and 140. However, fourth user 140 may not be monitoring the second user 120 if there would be little reason for the two of them to need to communicate directly. While the team will generally include users with reciprocal monitoring and communication relationships, it is also possible that the team will include one or more members that have asymmetrical monitoring relationships, they can monitor others without being monitored or are monitored by others that they do not monitor. For example, the first user 110 is monitoring the third user 130, but the third user 130 may not be monitoring the first user 110.

The computer system 101 includes a display 102 that provides an interface to the first user 110 for using the presence detection system. The interface for the presence detection system includes video presence indicators 103, 104, 105 for monitoring the presence of the other users 120, 130, 140. The video presence indicators 103, 104, 105 are real-time video of the locations 122, 132, 142 associated with the users 120, 130, 140, such as their offices. In the example shown, the first user 110 can tell at a glance that the second user 120 and fourth user 140 are in their offices 122, 142 and the third user 130 is out of her office 132. The video presence indicators 103, 104, 105 use only a small portion of the total display 102 such that workspace is provided for other windows or applications 106. For example, the first user 110 may be working on writing a report in a word processor, have a communication application (e-mail or instant messenger) open, and have an administrative window for managing the video presence application open on the computer system while still monitoring the presence of the other users 120, 130, and 140. The computer system 101 also collects video data through a camera 108 and provides that video data to other computer systems to allow monitoring of the location 112 of the first user 110.

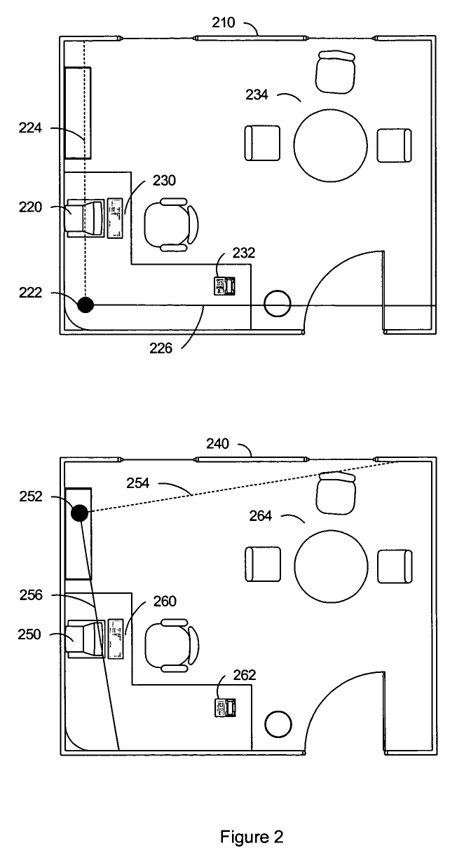

FIG. 2 shows diagrams of two locations with camera placements. The video presence detection system provides more information than simply whether another user is present or not. The real-time video provides visual reference for one or more work areas to indicate to a viewer both whether the other user is there and what that other user is doing. For example, a user may be in their office, but may be on the telephone, engaged in a conference, or working diligently on a project in such a way as to discourage interruption. Video presence detection enhances communication and functions similar to peering into someone's office to see whether they are available for a conversation. Because it is real-time and persistent, it also allows users to be more opportunistic in initiating communication. When two users notice that they are not presently engaged, they may initiate unstructured, “water cooler” conversation.

The first office location 210 includes three major work areas. There is a workstation area 230, a telephone area 232, and a conference table area 234. The camera 222 provides a wide angle view of the office, as shown by the sight lines 224 and 226, that includes all three work areas 230, 232, 234. The camera placement is relatively close to the computer system 220, which minimizes the need run cables over a long distance and provides the best view of the primary work area for the office, the workstation area 230.

The second office location 240 shows a similar office layout with a workstation area 260, a telephone area 262, and a conference table area 264. However, an alternate location for the camera 252 is shown to provide a wide angle view of the office, indicated by the sight lines 254, 256. Again the camera placement was selected relatively close to the computer system 250 and captures all three work areas 260, 262, 264. Note that alternate camera placements could include views from the vicinity of the door or behind the conference table area 264. Ceiling mounted or multiple cameras would also be a possibility for monitoring the multiple work areas within the example office locations 210, 240.

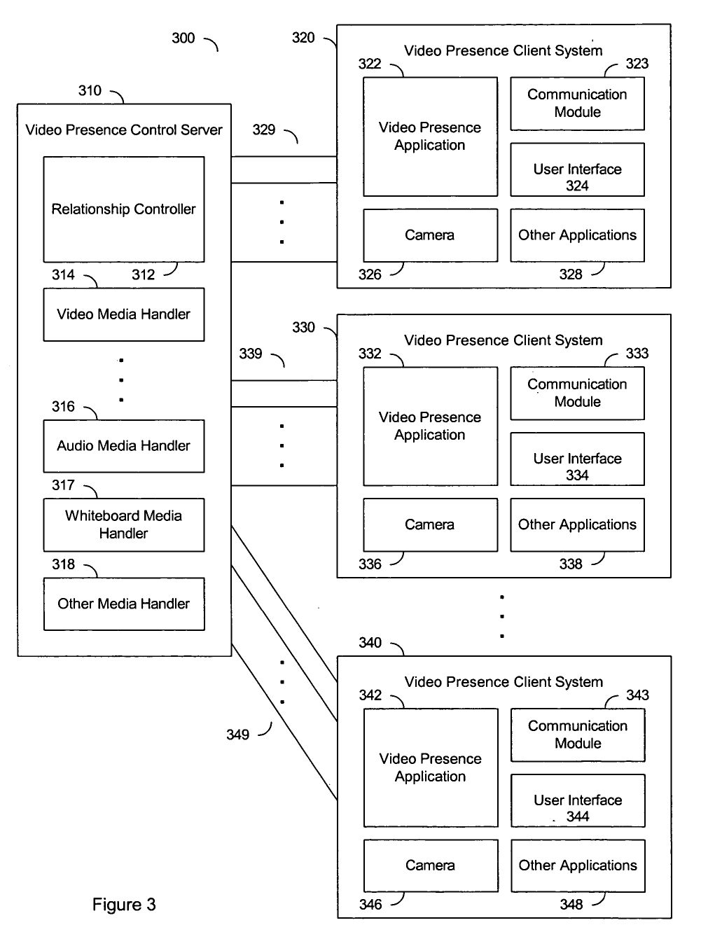

FIG. 3 shows an example client/server architecture for a video presence detection system 300. A video presence control server 310 provides administrative control and media handling for media data exchange among a number of video presence client systems 320, 330, 340. The video presence control server 310 may support any number of video presence client systems 320, 330, 340. Each of the video presence client systems 320, 330, 340 is a computer system and peripheral devices in communication with the video presence control server 310 over a network. In many embodiments, the network is the Internet or a corporate intranet or extranet. However, any network configuration supporting the transfer of data with sufficient bandwidth for video and administrative exchanges may be employed, including various wireless, communication, and proprietary networking technologies.

The video presence control server 310 includes a relationship controller 312 that oversees the administration of data exchange among the video presence client systems 320, 330, 340. The relationship controller 312 receives control messages from the video presence client systems 320, 330, 340, processes the control messages to establish media data routing, and provides appropriate responses back. The relationship controller 312 establishes a single control channel with each video presence client system 320 for the exchange of control messages.

In the embodiment shown, the video presence control server 310 uses an extensible architecture for coordinating one or more media data types. Each of the media handlers 314, 316, 317, 318 uses a single channel allocated by the relationship controller 312 for each video presence client system 320, 330, 340 involved in exchanging that media type. The video presence control server 310 includes a video media handler 314, an audio media handler 316, a whiteboard media handler 317, and another media handler 318. The video media handler 314 provides for the exchange of video data for use in video presence indicators on the video presence client systems 320, 330, 340. The video media handler 314 provides persistent real-time video connections among selected video presence client systems 320, 330, 340 based upon the relationships established by the relationship controller 312. The audio media handler 316 provides voice over IP communications, the whiteboard media handler 317 provides an online whiteboard collaboration tool, and the other media handler 318 may include any number of other collaboration applications. The audio media handler 316, the whiteboard media handler 317, and the other media handler 318 provide additional collaboration tools for teams using the video presence detection system 300, enhancing their opportunistic and scheduled communications.

The video presence client system 320 includes a video presence application 322, a communication module 323, a user interface 324, a camera 326, and other applications 328. The video presence application 322 oversees operation of the communication module 323 for exchanging control and media data with the video presence control server 310. The video presence application 322 also oversees operation of the user interface 324, which provides video presence indicators, relationship management functions, and basic application administration to the user. The video presence application 322 may include integration with other applications 328, such as collaboration applications based upon media handled by the video presence control server (VoIP, whiteboard, etc.) or independent applications (e-mail, instant messenger). The video presence application 322 may also oversee operation of the camera 326 for collecting video data to be provided to other video presence client systems 330, 340 through the video presence control server 310.

The other video presence client systems 330 and 340 include the same components as the first video presence client system 320: video presence applications 332, 342, communication modules 333, 343, user interfaces 324, 344, cameras 336, 346, and other applications 338, 348.

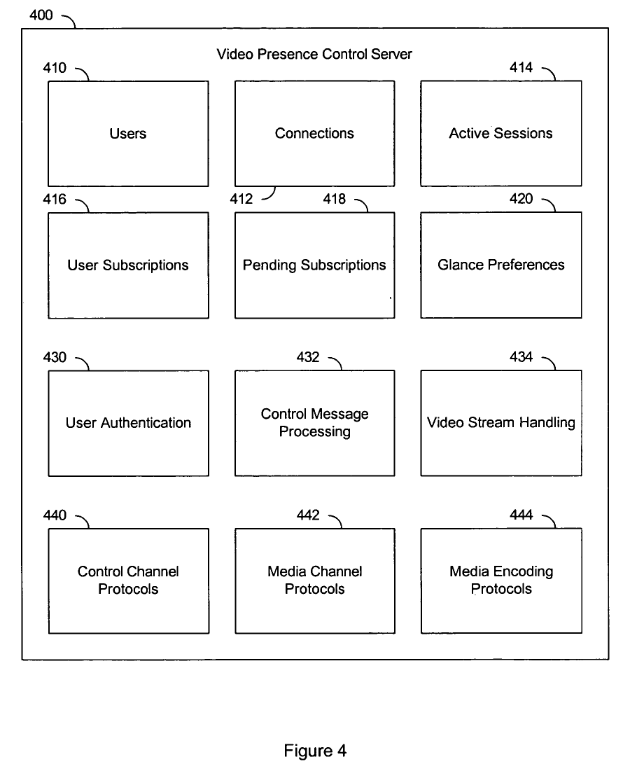

FIG. 4 shows an example video presence control server 400. The video presence control server 400 includes components for administration of relationships among a number of users associated with video presence client systems. The video presence control server 400 includes data sources and related database structures, a number of server functions, and a number of protocols for communicating with the video presence client systems.

The data sources used by the video presence control server 400 include a users module 410, a connections module 412, an active sessions module 414, a user subscriptions module 416, a pending subscriptions module 418, and a glance preferences module 420. The users module 410 maintains information regarding users connected to the video presence control server 410. Information stored in the users module 410 includes user ID, user name, and network address. The connections module 412 maintains information regarding the allocation of channels among the client systems and the state of those connections. Information stored in the connections module 412 includes user information, security/authentication information, IP address and hostname, subscription identifiers, session identifiers, glance identifiers, response permissions, and version control. The active session module 414 maintains information regarding active sessions. The active session module 414 includes session IDs, media channel associations, creator user ID, member user IDs, invitee user IDs, security/authentication information, and a description of the session. The user subscriptions module 416 and the pending subscriptions module 418 maintain information about active and pending subscriptions among users. The user subscriptions module 416 and pending subscriptions module 418 includes user ID pairs for active and pending subscriptions. Pending subscription ID pairs are moved to the user subscriptions module 416 when the subscription is accepted by both parties and removed if either party rejects the subscription. The glance preferences module 420 maintains information regarding whether or not the user accepts glances at his or her video data and what permissions are required.

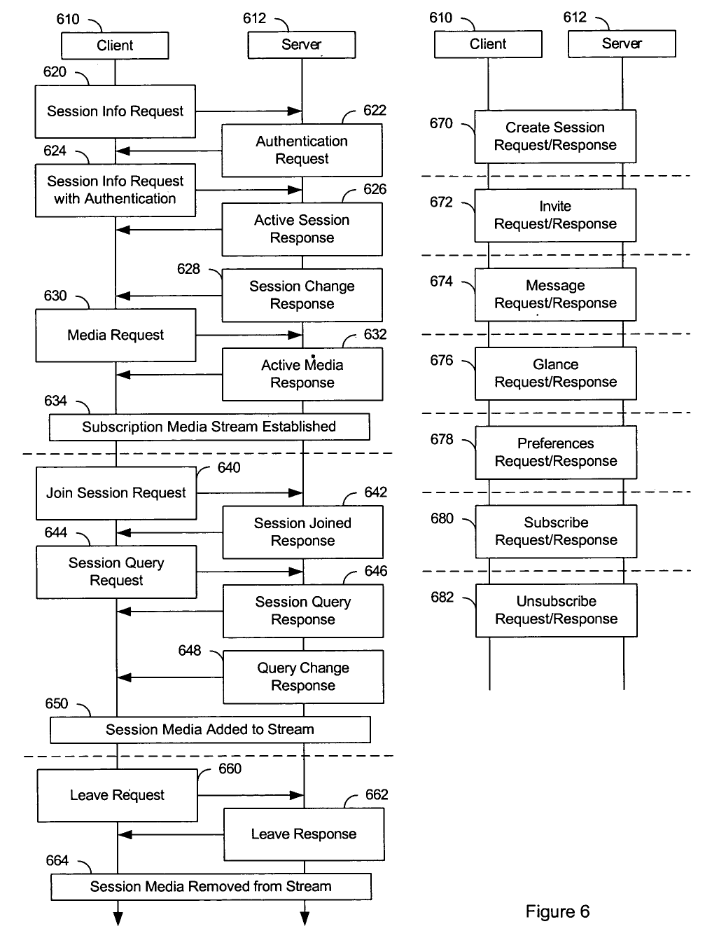

The video presence control server 400 includes a user authentication module 430, a control message processing module 432, and a video stream handling module 434 to provide server functions in conjunction with the data sources described above. The user authentication module 430 users stored security and authentication information to verify the identity of client systems and users communicating with the video presence control server 400 prior to allowing modification of subscription, session, and glance information or access to media streams. The control message processing module 432 includes the processes for receiving, evaluating, executing, and responding to control messages received from the client systems. Example control message exchanges are detailed below with regard to FIG. 6. The video stream handling module 434 includes the processes for managing the receipt and transmission of video data streams.

The video presence control server 400 uses a number of protocols to govern communications with the client systems. The protocols include a combination of control channel protocols 440, media channel protocols 442, and media encoding protocols 444. The protocols define the way in which information is transferred between the video presence control server 400 and the video presence detection applications running on the client systems. In one embodiment, the control channel protocols 440 include TCP and SSCP (see Appendix A for protocol description), the media channel protocols 442 include SDP and RTP/UDP, and the media encoding protocols 444 include H.261. Note that a variety of communication and media encoding protocols may be used in conjunction with the described invention and various embodiments.

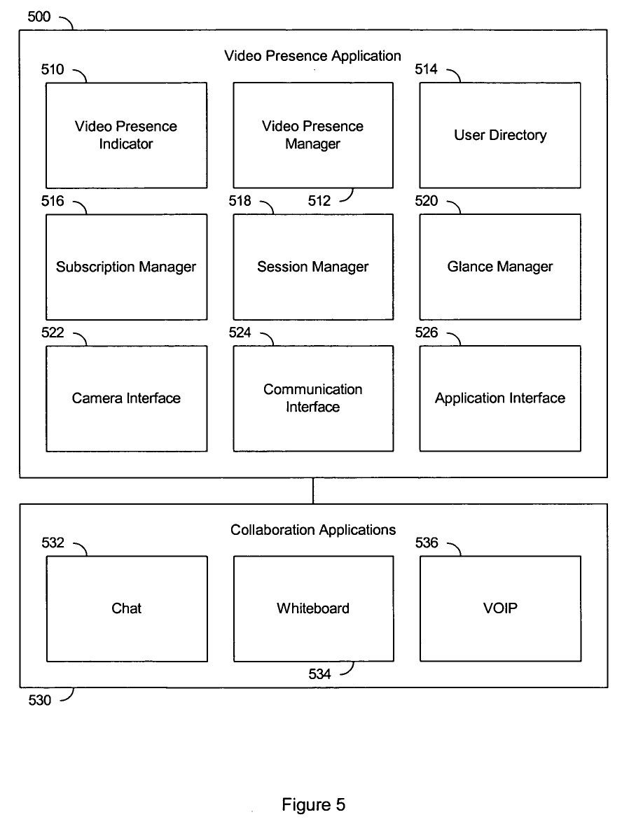

FIG. 5 shows an example video presence application 500. The video presence application 500 provides video presence detection to a user accessing the application and oversees communication of video data and control messages among multiple client systems running similar applications. The video presence application 500 runs on a video presence client system, such as a personal computer with a peripheral digital video camera. The video presence application 500 may operate in a client/server environment as described with regard to FIGS. 3 and 4. In an alternate embodiment, the video presence application 500 operates in a peer-to-peer environment with other video presence client systems.

The video presence application includes a video presence indicator 510, a video presence manager 512, and a user directory 514. The video presence manager oversees operation of a subscription manager 516, a session manager 518, and a glance manager 520. The video presence application 500 also includes a camera interface 522, a communication interface 524, and an application interface 526 for interaction with other system resources.

The video presence indicator 510 is a graphical user interface component that provides real-time video of the other users being monitored. For example, the video presence indicator 510 may include several thumbnail size video images in a window or embedded in a frame (such as a task bar). The video presence manager 512 allows the user to manage the relationships, connections, and preferences that determine who is monitored and how. The video presence manager 512 also allows the user to manage who has access to his or her video stream through subscriptions, sessions, or glances. The user directory 514 provides a listing of all other users to assist in identifying those available for subscriptions, sessions, or glances. The user directory 514 may also include contact information for other users, such as telephone, instant messenger IDs, e-mail addresses, physical addresses, and other information to be used in conjunction with video presence detection. In one embodiment, the user directory 514 is integrated with a larger directory service, such as a corporate directory.

The subscription manager 516, session manager 518, and glance manager 520 provide an interface for management of a user's subscriptions, sessions, and glances. The subscription manager 516, session manager 518, and glance manager 520 are sub-functions of the video presence manager 512 and may correspond to menu options and corresponding option windows, menus, and wizards for establishing, maintaining, and terminating subscriptions, sessions and glances.

The camera interface 522, communication interface 524, and application interface 526 utilize API's for accessing system resources and other applications. The camera interface 522 allows the video presence application 500 to access the data generated by an attached video camera and may also confer control over camera functions through drivers, device managers, or associated software. The communication interface 524 allows the video presence application 500 to access the communication channels of the client system for establishing video and control data streams. The application interface 526 allows the video presence application 500 to integrate with communication and collaboration applications 530. The collaboration applications shown include chat application 532, whiteboard application 534, and voice over IP application 536. These applications may be fully integrated into the video presence application such that they are initiated and managed through the video presence application itself or may be independent applications that simply share data with the video presence application 500.

FIG. 6 shows an example protocol for control messages between a video presence client system 610 and a video presence control server 612. In the example protocol, the client 610 initiates communication by sending a session information request 620 to the server 612. The server 612′ responds with an authentication request 622, in order to establish that the client 610 has complied with security protocols and is a legitimate user of the system. The client responds with a session information request with authentication 624. In an alternate embodiment (not shown), the session information request 620 automatically includes authentication credentials. However, using a challenge-response mechanism, rather than including authentication in the initial request, provides enhanced security. The challenge-response mechanism allows a session specific secret key to be exchanged between client system 610 and the server 612 without disclosing the key to an eavesdropper. In one embodiment, an adaptation of the Diffie-Hellman key agreement is used. The initial request from the client system 610 includes the client's session-specific public key that is required by the server 612 to generate its session-specific public key such that both the client system 610 and server 612 can establish the shared secret. In this way, the authentication credentials are then sent to the server 612 in an encrypted form (using the session-specific shared secret established by the Diffie-Hellman key agreement) so they are not exposed in clear-text form to an eavesdropper.

Once the server 612 has verified the credentials submitted with the session information request 624, an active session response 626 is provided. The active session response 626 provides a list of the current users and sessions available on the system. Once the client 610 is connected to the server 612, session change responses 628 will be provided automatically to update the client 610 on changes in the current user and session list. The client 610 sends a media request 630 based upon the list of current users and the subscriptions currently active on the client 610. The server 612 responds with an active media response 632 that provides the client 610 with the information regarding the location (channels) of the desired media streams. The client 610 can then establish a connection with the identified stream locations. In this way, the subscription media streams are established 634 for any active subscriptions with users presently connected to the system. Note that media streams are not yet established for any active sessions. A session join request is required to join an active session.

The example now assumes that the active sessions returned by the active session response 626 or the session change response 628 included at least one session of interest to the user of the client 610. A join session request 640 is sent to the server 612. The server 612 issues a session joined response 642 if the client 610 is eligible to join the session (as defined by the user that created the session). The client 610 then sends a session query request 644 to identify the users and media locations for the session. The server 612 responds with a session query response 646 that provides the user and media location information. Thereafter, the server 612 will provide a query change response 648 to update the client 610 as to any changes in the session users or media locations. Based upon the information in the session query response 646 or query change response 648 media streams are added 650 for the users in the session.

The client 610 is also able to leave a session when the user no longer wishes to monitor the members of the session (or be monitored). The client 610 sends a leave request 660. The server answers with a leave response 662 and the session media streams are removed 664 from the media streams received by the client 610.

There are a number of other request/response pairs that are used for various control functions between the client 610 and the server 612. For example, there are: a create session request/response 670 for initiating a new session; an invite request/response 672 for inviting other users to a session; a message request/response 674 for sending messages to other users; a glance request/response 676 for initiating a glance at another user; a preference request/response 678 for updating glance or other preference information stored by the server 612; a subscribe request/response for adding a new user to the subscription list for the client 610; and an unsubscribe request/response for removing a user from the subscription list for the client 610.

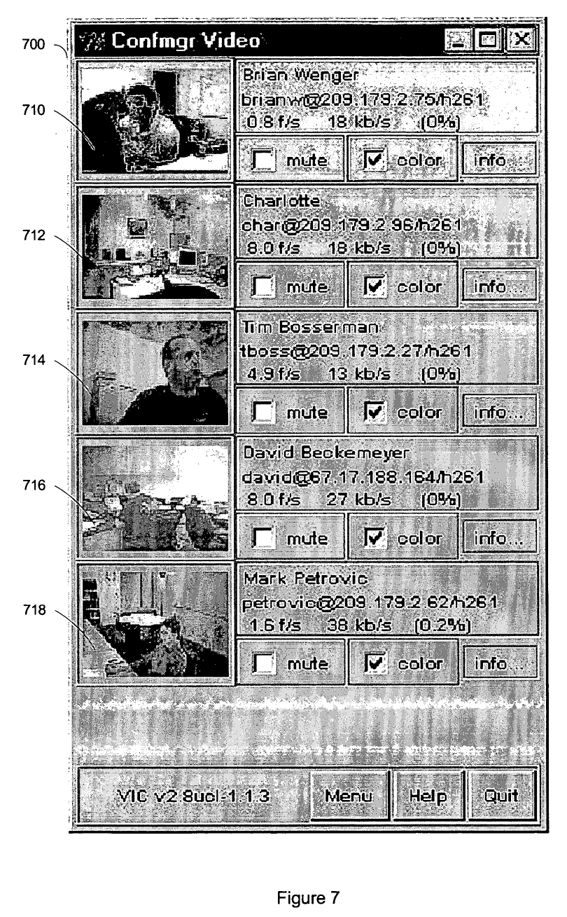

FIG. 7 shows an example user interface 700. The example user interface 700 includes thumbnail real-time video as video presence indicators 712, 714, 716, 718.

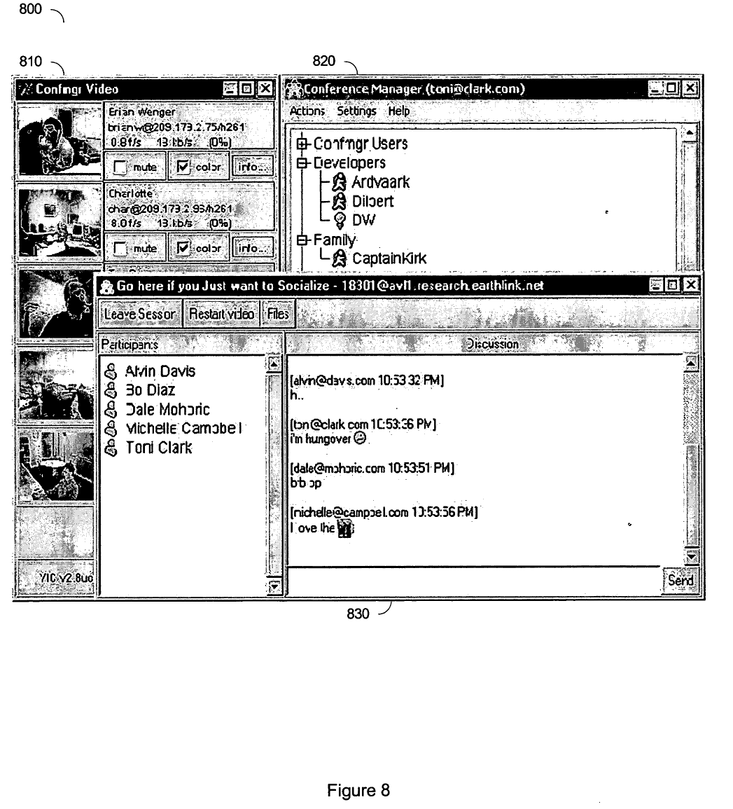

FIG. 8 shows an example user interface 800. The example user interface 800 includes a video presence indicator window 810, a video presence manager window 820, and a collaboration application window 830. In the example shown, the collaboration application is online chat.

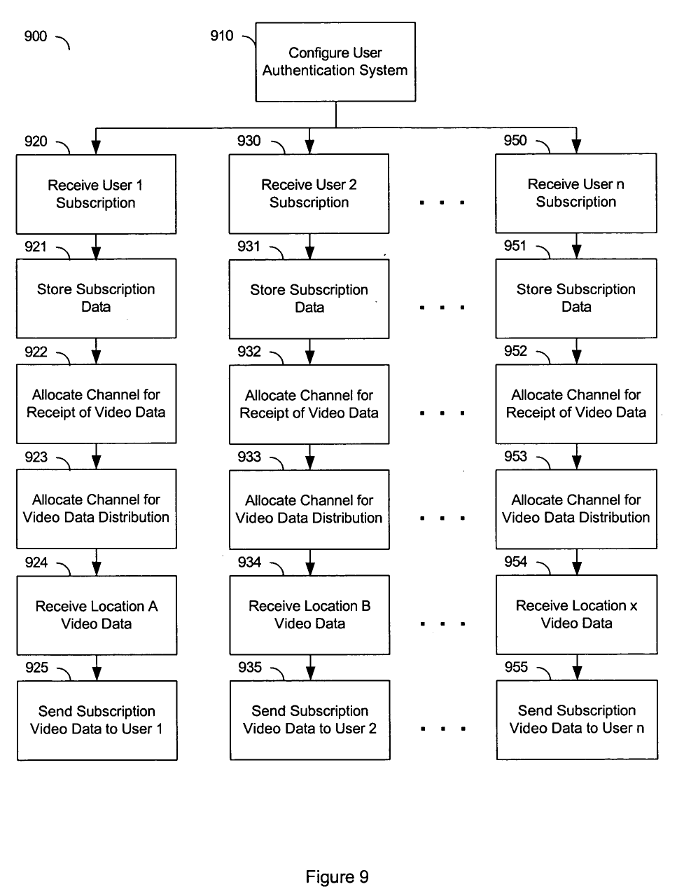

FIG. 9 shows a method 900 of video presence detection based upon user-to-user subscriptions. The method 900 may be executed using one or more of the embodiments shown and described above with regard to FIGS. 1-8. The method 900 includes three example users, but the method 900 may include any number of users. The system is configured 910 with user authentication information for each of the users. For example, usernames and passwords may be assigned to each member of an organization or the users select username and passwords the first time they access the system. The system receives 920 a subscription from User 1. The subscription identifies one or more other users, such as Users 2-n. The subscription may be reciprocal, allowing users to monitor one another, or may be unilateral, either specifying the destination user to be the recipient of video data from User 1 or the source of video data to User 1. The system stores 921 the subscription data. Storing the subscription data allows the system to manage the user relationships and connections and act as a data source for the users. The system allocates 922 a channel for receiving video data from the user being monitored. In reciprocal subscriptions, the system allocates a channel for each of the users. The system allocates 923 a channel for video data distribution. In reciprocal subscriptions, the system allocates a channel for each user. In some embodiments, the system communicates the channel allocations to the relevant users through control messages on a separate communication channel. The system receives 924 video data from the location of User 1 to provide to other subscribers and sends 925 subscription video data to User 1 in accordance with the stored subscription data. The sending and receiving of video data by the system is made through the allocated channels.

FIG. 9 shows similar steps for Users 2-n. Subscriptions are received 930, 950, subscription data is stored 931, 951, channels for receipt of video data are allocated 932, 952, channels for video distribution are allocated 933, 953, video data from the users' locations are received 934, 954, and video data for the users' subscriptions are sent 935, 955. The method 900 may be executed with each user as they initiate contact with the system and subscriptions may be maintained, modified, and discontinued as the user group and the needs of individual users change.

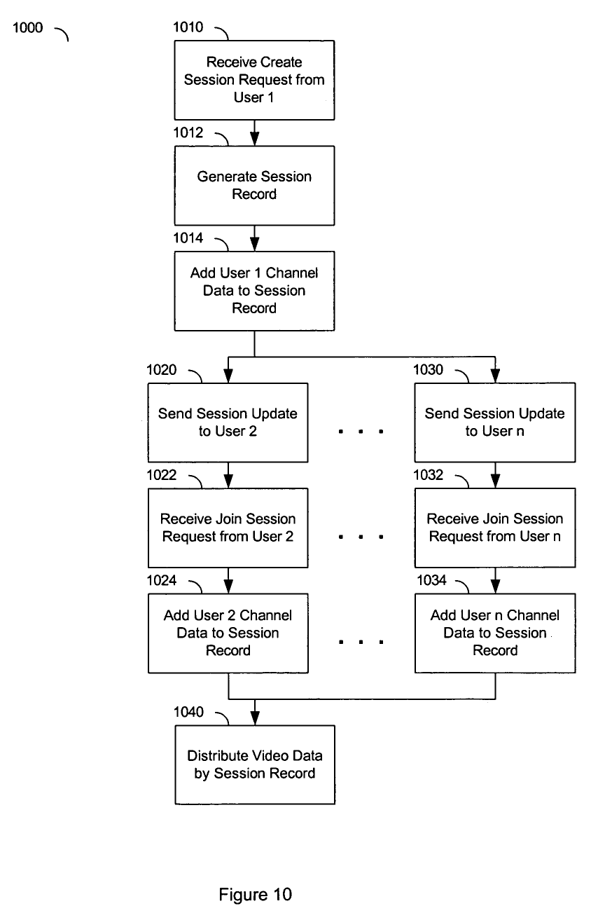

FIG. 10 shows a method 1000 of video presence detection based on multi-user sessions. Method 1000 assumes that the users participating in the session are connected to the system and channels have already been identified for receiving video data from each. User connections and allocation of channels need not happen before the method 1000 is initiated and may be done concurrent with various steps of method 1000. The system receives 1010 a create session request from User 1. The system generates 1012 a session record for the session. For example, the system may generate a session ID and create an entry in a session data source based upon information contained in the create session request. The system adds user 1 channel data to the session record. For example, the system may link the user ID to a table identifying the channel that is receiving video data from the user's location. The system then sends 1020, 1030 session updates to the other users connected to the system to alert them of the existence of the newly created session. The receiving users may decide whether or not they are interested in joining the new session. If they are, a join session request will be received 1022, 1032 from the interested users. The system will add 1024, 1034 the channel data for the users joining the session to the session record. Video data for all users in the session will be distributed 1040 to all of the other users in the session based upon the channel information in the session record.

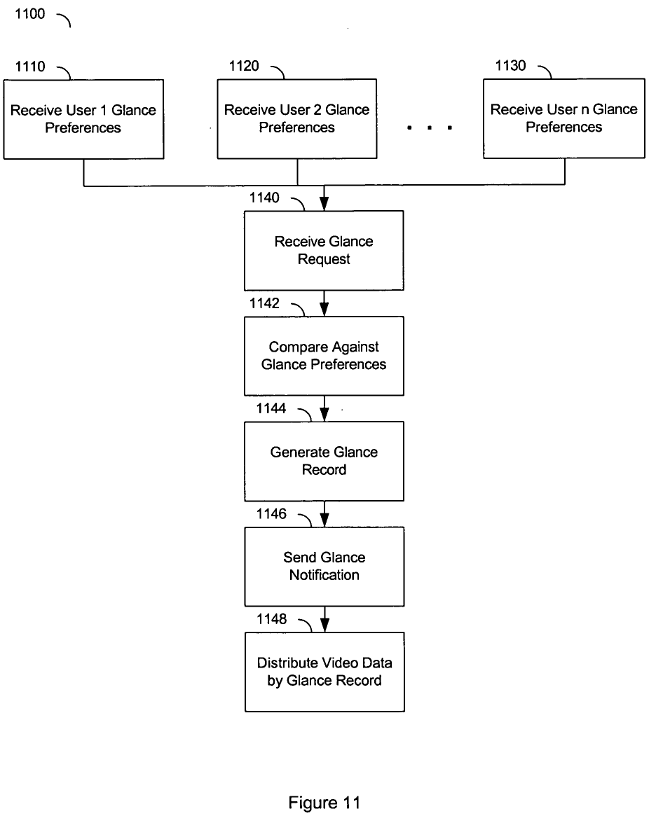

FIG. 11 shows a method 1100 for video presence detection using short-term glances. The system receives 1110, 1120, 1130 glance preferences from various users of the system. The glance preferences define whether or not the system should allow other users to receive the video data from a user's location. The glance preferences may vary in complexity, from a simple allowed or not allowed, to notice and permission standards, to complex conditions based upon user relationships or individual users. When a user attempts to glance at the video data of another user, the system receives 1140 a glance request. The system compares 1142 the glance request against the glance preferences of the target user. If the glance is within the bounds of allowable glances, the system generates 1142 a glance record. The glance record identifies the initiating user and the target user, along with the channel information for the target user's video data. The system sends 1146 a glance notification to the target user to notify them that another user is viewing their video data. Note that the glance notification may be based upon glance preferences and some users may not desire notification or may require that they accept the new glance before the system is allowed to share the video data with the initiating user. Video data is then distributed 1148 in accordance with the glance record, allowing the initiating user to view the video data of the target user.

### Appendix A-Simple Synchronous Conferencing Protocol (SSCP)

The SSCP is an unpublished protocol as of the filing of this document. The following protocol description is provided to support the embodiments described above. The SSCP is used for conference control and initiation of tightly coupled conferences. The protocol provides services for management of a set of participants, management of a set of application/media sessions, and access control.

The Internet Multimedia Conferencing Architecture currently comprises conference control elements only for loosely coupled conferences. Many conferences have more formal policies, in particular with respect to the set of participants that are allowed to participate. The ITU T.120 and H.320 series recommendations address the problems of tightly coupled conferences, but they are difficult to deploy and are not firewall friendly.

The SIP protocol could support the features outlined below, however it would be far more complex, requiring a number of SIP extensions. The SSCP defines a much simpler protocol implementing basic conference initiation and control, specifically: 1) management of the set of members participating in the conference; 2) management of the set of applications/media that constitute the conference; 3) simple conference (group) and private text messaging; and 4) limited presence. The protocol does not support other conference features, such as floor control.

The SSCP protocol is a request/response protocol, similar to the Hypertext Transport Protocol (HTTP 1.1) [RFC 2068]. SSCP is designed to support the IETF multimedia data and control architecture, including the real-time transport protocol (RTP) [RFC 1889] and the session description protocol (SDP) [RFC 2327].

A client sends one or more requests to the server and receives one or more responses from the server. Requests take the form of a request method and protocol version, followed by a MIME-like message containing request modifiers, client information, and possible body content. Responses take the form of a protocol version and a success or error code, followed by a MIME-like message containing server information, and possible body content.

All requests and responses for a given client connection are carried over the same TCP connection. Each client TCP connection may be associated with only one conference session at a time.

The client typically begins a server interaction by sending an INFO request to obtain information about the active sessions. The server may respond with a 401 (Authorization Required) response containing Authentication information. The client then reissues the INFO command with the proper credentials (presumably obtained through user interaction). The authentication exchanges occur using encryption to prevent interception.

Upon successful response to the INFO request, the client must be ready to receive INFO response messages until it sends a different request or receives an error response (a response other than 200). The server will transmit INFO response messages to the client whenever a change in the list of active sessions occurs (as when a different client creates or terminates a session).

After successful authentication, the client may transmit a MEDIA request to obtain information such as port assignments for active media streams. The client can use this information to coordinate the media applications it supports.

A client can transmit a CREATE request to create a new session or a JOIN request to join an existing session. The multimedia streams associated with the session are negotiated between the client and server using an offer/answer model and the session description protocol (SDP).

The client that creates a conference is considered the Convener of that conference. Other clients that join the conference are called Participants.

Each conference has associated with it the following information: a unique Conference-ID; a short Description (Subject); and an optional Password. While participating in a conference, the client may send a QUERY request to obtain the list of participants of the conference. As with the INFO request, a successful response to the QUERY request results in the server sending an initial QUERY response, followed by additional QUERY response messages as members join and leave the conference.

The client transmits a LEAVE request to leave a conference. If the client was the Convener of the conference, a 404 (Not found) response will be sent to all active QUERY clients on the conference, effectively terminating the conference. If the client sending the LEAVE request is not the Convener of the conference, only that client will be removed from the conference and the server will transmit the new participant list to all active QUERY clients on the conference.

Closing the connection terminates the interaction. The server LEAVEs the active conference session, if any, on behalf of the client.

At all times, the client MUST be prepared to accept 1xx Out of band responses from the server. The client MAY ignore these requests, but it must at least accept them and discard them. Out of band responses are used to transmit messages, invitations, and notifications.

An SSCP message is either a request from a client to a server, or a response from a server to a client (SSCP-message=Request|Response). Both Request and Response messages use the generic-message format of RFC 822. Both types of messages consist of a start-line, one or more header fields (also known as “headers”), an empty line indicating the end of the header fields, and an optional message-body.

The Request-Line begins with a method token, followed by the protocol version.

The methods are defined below. Methods that are not supported by a client or server cause a 501 (Not Implemented) response to be returned. As in HTTP, the Method token is case-sensitive (Method=“INFO”|“CREATE”|“JOIN”|“LEAVE”|“QUERY”|“INVITE”|“MESSAGE”|“GLANCE”|“MEDIA”|“PREFS”|“SUBSCRIBE”|“UNSUBSCRIBE”).

The INFO method queries the server as to the active sessions. A success response includes the list of active sessions in the message body, one per line. The form is: Session-info=session-id “:” Convener “:” Subject. The server places the client connection into the INFO state, where the server will deliver updates to the active session list to the client in the form of INFO response messages until the client issues a different request method or closes the connection.

The CREATE method initiates a multimedia session. The message body contains a description in session description protocol format (SDP) [RFC 2327]. The client indicates the type of media it is able to receive and the media it is capable of transmitting, including parameters such as network destination. A success response MUST indicate in its message body which media the server can accept.

The client MAY specify a port number in the media lines of the SDP message. However, if the port number is zero, the server MUST assign a port number to the media stream and provide that value in the response, if it accepts that stream.

A client uses JOIN to connect to an existing session. As with the CREATE method, session description information is provided in the message-body and the server responds with the final session description information.

The LEAVE request indicates to the server that the client wishes to disconnect from the session that it joined with a prior CREATE or JOIN request.

The client wishes to obtain the list of participants on the currently connected conference. A success response returns the list of participants and the server places the client in the QUERY state. The server transmits an initial QUERY response messages and additional QUERY response messages when the list of participants changes or if the session is terminated by the Convener.

The participant information for the session is provided in the body of the message, one participant per line, as follows: Participant-info=user-info “:” convener-IP-address “:” convener-hostname.

The client wishes to request that a specific individual be asked to join a conference. The client must be participating in the conference (via JOIN or CREATE). The To header specifies the user to be invited to the conference. That user, if available, will receive notification in the form of a 122 out of band response.

If the user specified in the To header is associated with more than one session (multiple clients in different locations), the server SHOULD transmit a 122 Invitation response to each of the client sessions (each location).

Send a message to the participants in a conference or to a specific individual. The body of of the request contains the plain text content of the message. If a To header is present, the message is delivered to the specific user (private message) if available, in the form of a 124 out of band response. If no To header is present, the message is delivered as follows. If the client is participating in a conference, all participants on the conference receive the message. If the client is not participating on a conference, the message is transmitted to all other clients also not participating on a specific conference. These group distribution forms of messages are transmitted by the server to those clients using the 120 out of band response.

If the user specified in the To header of a private message is associated with more than one session (multiple clients in different locations), the server SHOULD transmit the 124 response to each of the client sessions (each location).

A glance establishes a special form of temporary media distribution. The client specifies the destination user in the To header and includes SDP information for the video media in the body of the request. If the specified user is available and accepting glances, the server sends that user a notification using the 128 out of band response, and establishes a bidirectional distribution of the video media between the two clients. The server responds with the SDP information for the temporary connection. The media distribution automatically terminates after 15 seconds.

The client wishes to query the server to obtain information about specific media streams. The client specifies each type of media it wishes to obtain information for in the SDP information. The server responds with all matching media channels in use.

The PREFS request may be used to set client defaults or preferences for the session. The body of the request is a list of preference settings of the following form: preference-setting=action SP “parameter [“,” parameter]; action=“permit”|“deny”. The parameters are numeric values corresponding to the out of band responses that the client is willing to accept or wishes to deny. This command may be used to block private messages (124) and glances (128). By default, these operations are permitted. Preferences set with the PREFS request remain in effect for the duration of the session. Preferences may be changed with subsequent PREFS requests.

To request a subscription to a specific user, the client issues a SUBSCRIBE request. The client MUST provide a To header indicating the party to which the client wishes to subscribe.

Subscriptions are permanent bidirectional relationships in which two users share media. These relationships SHOULD be maintained by the server and automatically established when clients sign on.

When a client wishes to terminate a subscription, it sends the UNSUBSCRIBE request. The client MUST provide a To header indicating the user ID that it is unsubscribing from.

After receiving and interpreting a request message, the server responds with an SSCP response message. The first line of a Response message is the Status-Line, consisting of the protocol version (SSCP/1.0) followed by a numeric Status-Code and its associated textual phrase.

The Status-Code is a 3-digit integer result code that indicates the outcome of the attempt to satisfy the request. The Reason-Phrase is intended to give a short textual description of the Status-Code. The first digit of the Status-Code defines the class of response. SSCP/1.0 allows 6 values for the first digit: 1xx: Out of band—information from the server, continuing to process the request; 2xx: Success—the action was successfully received, understood, and accepted; 3xx: Redirection—further action needs to be taken in order to complete the request; 4xx: Client Error—the request contains bad syntax or cannot be fulfilled at this server; 5xx: Server Error—the server failed to fulfill an apparently valid request; 6xx: Global Failure—the request cannot be fulfilled at any server. Note that SSCP adopts many HTTP1.1 response codes. The following codes are implemented: 120 Message. 121 Update notice, 122 Invitation, 124 Private Message, 126 Notify, 128 Glance, 132 Subscribe, 134 Subscribed, 136 Unsubscribed, 200 OK, 401 Authorization Required, 403 Password Required, 404 Not found, 406 File Name Not Acceptable, 408 Cannot open, 470 Logging in too fast, 480 User Unavailable, 481 User Signed in more than once, 484 Missing or invalid destination user, 486 Busy, 486 Cannot join more than one channel, 501 Not Implemented, 506 Authentication Failure, 511 Jabber failed, 603 Not Accepting Glances/Private Messages, 606 Media Not Acceptable.

The server provides information and notifications to clients using out of band responses to pending requests. The types of out of band responses include: 120 Message, 122 Invitation, 124 Private Message, 126 Notify, 128 Glance, 132 Subscribe, 134 Subscribed, 136 Unsubscribed.

Upon receiving an out of band response, the client MUST accept the response and continue to wait for other specific (non-1xx) responses to the outstanding request. The client SHOULD appropriately process the out of band response.

The 120 Message response MUST include a message body containing the message text and a From header indicating the source of the message (sender). This response is used by the server to transmit group messages to clients.

The 122 Invitation response is used to transmit an invitation to join a conference to a specific user. The response MUST include Conference-ID, From, and Subject header fields indicating the conference to join and the sender of the invitation.

The 124 Private Message response is used to transmit private messages from one individual to another. The server MUST provide To and From headers, and a message body containing the content of the text message.

The server transmits 126 Notify responses to clients to inform them of changes to the set of active users. The body of the response contains information for each user, one per line, as follows: user-info=user-id-info “:” ip-address “:” hostname; user-id-info=user-id “(” full-name “)”

When the server establishes a glance, it SHOULD transmit a notification to the destination user in the form of a 128 Glance response. The response MUST include a From header indicating the user initiating the GLANCE request.

The 132 Subscribe response announces a SUBSCRIBE request from the party specified in the From header. The client SHOULD, presumably upon user interaction announcing the request, send a SUBSCRIBE request to accept the subscription or an UNSUBSCRIBE request to reject the subscription.

The server sends the set of subscriptions for the client with the 134 Subscribed response. The body of the message contains the subscribed users, one user-ID per line.

The server sends a 136 Unsubscribed response when another user terminates an existing subscription using the UNSUBSCRIBE request. The From header indicates the user-ID of the unsubscribing party. SSCP header fields are similar to HTTP header fields. The rules for extending header fields over multiple lines is not supported in SSCP. Each header field consists of a name followed by a colon (“:”) a SP and the field value. Field names are case-insensitive.

The Allow header field lists the set of out of band responses supported by the client. The purpose of this field is to inform the server of the out of band responses the client will process in the context of the request (Allow=“Allow” “:” response-code [“,” response-code . . . ]).

The values set with the PREFS request override the values set with the Allow header field.

If no Allow header field exists, the server defines implicitly the supported out of band responses to include 122 (Invite) for the INFO request and 120 (Message) for the QUERY request.

Regardless of the out of band responses specified by the Allow field, the client MUST accept all out of band responses, discarding or ignoring those it does not support.

The Authenticate response-header field MUST be included in 401 (Authorization Required) response messages. The field value consists of a challenge and the authentication scheme. SSCP implements a unique authentication scheme. It does not support HTTP “basic” authentication and it does not transmit any information in the clear. The details are described in Section 4.

A client that wishes to authenticate itself with a server MUST do so by including an Authorization request-header field with the request. The Authorization field value consists of credentials containing the authentication information of the client appropriate to the SSCP authentication scheme, as described in Section 4.

The Conference-ID header field uniquely identifies a particular conference. It is of the following form: Conference-ID=Conference-ID “:” local-id “@” host. CREATE, LEAVE, and JOIN requests MUST contain a Conference-ID header field. With LEAVE and JOIN requests, the Conference-ID indicates the target conference for the operation. In CREATE requests, the Conference-ID header field indicates the Conference-ID of the new session.

The Content-Length header field indicates the size of the message-body, as in HTTP/1.1.

The Content-Type header field indicates the media type of the message-body, as in HTTP1.1.

Clients MAY add the CSeq (command sequence) header field to requests. The CSeq header field contains the request method and a single decimal sequence number chosen by the requesting client, unique within a single session. The sequence number MUST be expressible as a 32-bit unsigned integer. The initial value of the sequence number is arbitrary. Consecutive requests with CSeq headers MUST contain strictly monotonically increasing and contiguous sequence numbers. The server SHOULD echo the CSeq value from the request in responses. The exception is 1xx out of band responses, since they are by definition out of band and MUST be accepted by clients, independent of the request.

The CSeq value allows the client to ensure a given response applies to the proper request.

Client requests MUST contain a From header field indicating the initiator of the request. The From header field in responses indicates the Convener of the session for active sessions. In other cases, the server copies the From header field from the request to the response.

A CREATE request MAY contain a Password header field, in which case it defines the Password for the session. The password value is transmitted using base64 encoding.

Clients that attempt to JOIN a session to which a password has been assigned must supply a matching password value.

The Subject header field contains information about the session. The Subject header field is intended for human users.

INVITE and GLANCE requests MUST contain a To header field specifying the target or destination user. MESSAGE requests MAY contain a To header field, indicating that the message is private.

The User-Agent header field provides information about the client software originating the request. The syntax and semantics are as in HTTP.

SSCP provides a challenge-response authentication mechanism which MAY be used by a server to challenge a client request and by a client to provide authentication information. It uses an extensible, case-insensitive token to identify the authentication scheme, followed by a credentials parameter appropriate to the given scheme.

The 401 (Unauthorized) response message is used by an origin server to challenge the authorization of a user agent. This response MUST include an Authenticate header field containing the applicable challenge (challenge=auth-scheme SP auth-param).

The “S1” authentication scheme has been deprecated and is no longer supported.

The “S2” authentication scheme uses Diffie-Hellman key agreement similar to RFC 2631 [RFC 2631] to establish a shared secret. The auth-param value in the Authenticate header is the Diffie-Hellman random public key, represented as a string of hexidecimal digits. The Diffie-Hellman public prime and generator are pre-defined for the “S2” authentication scheme. The generator used is 3. The decimal value of the public prime is: 258224987808690858965591917200301187432970579282922351 2830659356540647622016841194629645353280137831435903171972747492783.

The client is expected to retry the request, passing an Authorization header line, which is defined as follows: Authorization=“Authorization” “:” SP “S2” SP auth-info. The “auth-info” field is a base64 encoding of the client's computed Diffie-Hellman public key and credentials, as follows: public-key “:” user-name “:” encrypted-password. The “encrypted-password” sub-field is a base64 encoded result of applying the solitaire encryption algorithm [SCHNEIER] to the user's password using the Diffie-Hellman computed shared secret.

Like HTTP, LDAP, and many other protocols, SSCP is vulnerable to man-in-the-middle attacks.

### REFERENCES

[RFC 1889] Schulzrinne, H., Casner, S., Frederick, R. and V. Jacobson, “RTP: A Transport Protocol for Real-Time Applications”, RFC 1889, January 1996.
[RFC 2068] Fielding, R., Gettys, J., Mogul, J., Frystyk, H. and T. Bemers-Lee; “Hypertext Transfer Protocol—HTTP/1.1”, RFC 2068, January 1997.
[RFC 2327] M. Handley, V. Jacobson and C. Perkins, “SDP: Session Description Protocol”, RFC 2327, April 1998.
[RFC 2631] Diffie-Hellman Key Agreement Method, E. Rescorla, June 1999.
[SCHNEIER] Bruce Schneier, “The solitaire encryption algorithm”<http://www.counterpane.com/solitaire.html>.

### EXAMPLES

A. 1 INFO (initial login)
Client request:
INFO SSCP/1.0
From: blockja
Content-Length: 0
Server response:
SSCP/1.0 401 Authorization Required
Authenticate: S2
ED97768508DFAE41BE92AA1AE075FD6E404000BF7F64293D67F3760F2E83ED841 6C0E8A689C358286208EDE814B4513BA3E6
Content-Length: 0
Client request:
INFO SSCP/1.0
From: blockja
Authorization: S2
QjExRUZGQUIwMDMxNzY3NUUxNjg5QUNGRUFGNTM3NTZGRTU2NjFDRjBG QzI4RjNEMUY3RkQyMOU3NDc5REM4QkZCN0I1QkQxN0E4Q0FEQjVGMTQwMT g1QjBGN0E2MzdFOTFCMDpibG9ja2phO1RxYjhjemtEZ2NmWg==
Content-Length: 0
Server response:
SSCP/1.0 200 OK
From: blockja (Tim Bosserman)
Content-Length: 0
The server transmits another response when a session gets created:
SSCP/1.0 200 OK
From: blockja (Tim Bosserman)
Content-Length: 57
14403@thinkpad:smithjrbh (Billy Smith Jr):Shift Meeting
A.2 CREATE
Client request:
CREATE SSCP/1.0
Conference-ID: 14403@thinkpad
From: smithjrbh
Subject: Shift Meeting
Password: cGVuZXRyYWJsZQ==
Content-Type: application/sdp
Content-Length: 68
v=0
o=
s=
c=IN IP4 209.178.131.54
t=0 0
m=video 0 RTP/AVP 0
Server response:
SSCP/1.0 200 OK
Conference-ID: 14403@thinkpad
From: smithjrbh
Subject: Shift Meeting
Content-Type: application/sdp
Content-Length: 71
v=0
o=
s=
c=IN IP4 209.178.131.54
nt=0 0
m=video 15914 RTP/AVP 0
Note that the server has assigned port 15914 for the video media stream.
A.3 QUERY
Client request
QUERY SSCP/1.0
Conference-ID: 14403@thinkpad
From: blockja
Content-Length: 0
Server response:
SSCP/1.0 200 OK
Conference-ID: 14403@thinkpad
From: smithjrbh (Billy Smith Jr)
Subject: Shift Meeting
Content-Length: 159
smithjrbh (Billy Smith Jr):209.178.131.54:pool0819.cvx1-bradley.dialup.earthlink.net
blockja (Tim Bosserman):209.179.2.27:dangermouse.research.earthlink.net
Subsequent response when a user leaves the conference:
SSCP/1.0 200 OK
Conference-ID: 14403@thinkpad
From: smithjrbh (Billy. Smith Jr)
Subject: Shift Meeting
Content-Length: 86
smithjrbh (Billy Smith Jr):209.178.131.54:pool0819.cvx1-bradley.dialup.earthlink.net

1. A video presence detection system, comprising:
a plurality of computer systems interconnected by a network, the computer systems located in a plurality of locations;
a plurality of cameras in the locations, each of the cameras in communication and collocated with one of the computer systems; and
a plurality of video presence modules for coordinating the display of video generated by the cameras, wherein each of the computer systems provides an interface for one of the video presence modules and the video presence modules provide continuous video of a user selected set of the locations using limited bandwidth for background monitoring of video presence.

2. The system of claim 1, further comprising a plurality of communication modules for sending and receiving video data, wherein each of the computer systems hosts one of the communication modules for sending video data from the collocated camera and the communication module sends a single video data stream.

3. The system of claim 2, wherein each of the communication modules receive video data corresponding to the continuous video of the user selected set of locations and wherein the multiple video data streams corresponding to the user selected set of locations are multiplexed into a single video data stream for each of the communication modules.

4. The system of claim 1, further comprising a control server in communication with the computer systems, the control server receiving video data generated by the cameras and providing video data to the video presence modules corresponding to the video data for the user selected set of locations.

5. The system of claim 1, wherein the video presence modules are integrated with at least one online collaboration module.

6. The system of claim 1, wherein the user selected locations correspond to a subscription list of other users associated with the locations in order to provide presence information based upon video from the locations of the other users.

7. The system of claim 1, further comprising a plurality of user interface modules for providing a graphical user interface for the video presence modules, wherein each of the video presence modules has an associated user interface module providing thumbnail icons of real-time video corresponding to the user selected set of locations.

8. The system of claim 1, wherein the video presence modules send and receive video data whenever the corresponding computer systems and cameras are on to provide constant video presence detection.

9. The system of claim 1, wherein the video presence modules allow a user to choose a connected location that is not one of the user selected locations to receive limited duration video data from the chosen connection.

10. The system of claim 1, wherein the cameras are situated in the locations to provide a view of a plurality of work areas within the locations.

11. A method of video presence detection, comprising:
receiving a plurality of video data streams from a plurality of client systems, wherein the video data streams correspond to video data generated at a plurality of locations corresponding to the client systems;
receiving user subscriptions for each of the client systems, the user subscriptions defining a subscription set of other client systems for each client system, wherein the client systems will receive video data corresponding to their set; and
sending a subset of the video data streams corresponding to the set for each client system to that client system.

12. The method of claim 11, further comprising allocating a plurality of channels for receiving video data from the client systems, wherein each channel corresponds to a single client system.

13. The method of claim 11, further comprising allocating a plurality of channels for sending video data to the client systems, wherein each channel corresponds to a single client system.

14. The method of claim 11, further comprising:
receiving session requests that define a session set of client systems for reciprocal exchange of video data streams; and
sending a subset of the video data streams corresponding to the session set to each client system in the session set.

15. The method of claim 14, further comprising allocating a plurality of channels for transmission of application data for at least one online collaboration tool for exchange among the client systems in the session set.

16. The method of claim 11, wherein each of the client systems has an associated user interface providing thumbnail icons of real-time video corresponding to the subscription set.

17. The method of claim 11, wherein receiving and sending video data streams occurs whenever the correspond client systems are on to provide constant video presence detection.

18. The method of claim 11, further comprising:
receiving a glance request from a first client system requesting a video data stream for a second client system that is not in the subscription set of the first client system; and
sending the video data stream corresponding to the second client system to the first client system.

19. The method of claim 18, further comprising:
storing glance preferences for the client systems;
verifying the glance preferences of the second client system prior to sending the corresponding video data stream; and
sending glance notification to the second client system.

20. The method of claim 11, wherein the video data stream received from each client system includes a view of a plurality of work areas within the locations corresponding to each client system.

21. A system for video presence detection, comprising:
a video presence indicator on a display of a networked computer system, the video presence indicator showing real-time video of a selected plurality of remote work locations with networked computer systems;
a video presence manager that governs the selection of the plurality of remote work locations for display in the video presence indicator; and
a subscription manager, the subscription manager providing a subscription list of remote locations to be included in the selected remote locations whenever the system is operating.

22. The system of claim 21, further comprising a session manager, the session manager providing a session list that identifies remote locations to be included in the selected remote locations for the duration of each session.

23. The system of claim 21, further comprising a glance manager, the glance manager providing a glance list of locations to be included in the selected remote locations for a limited duration.

24. The system of claim 21, further comprising a user directory used by the subscription manager to identify remote locations and corresponding users as candidates for addition to the subscription list.

25. The system of claim 21, further comprising an online collaboration tool for use in conjunction with the video presence indicator.
